(19) United States
(12) Patent Application Publication
(10) Pub. No.: US 2023/0110091 A1
(43) Pub. Date: Apr. 13, 2023

(54) SWITCHES ASSOCIATED WITH TOUCHPAD ZONES

(71) Applicant: HEWLETT-PACKARD DEVELOPMENT COMPANY, L.P., Spring, TX (US)

(72) Inventors: Derek Kanas, Spring, TX (US); Tony Moon, Spring, TX (US); Hung-Sung Pan, Taipei City (TW)

(73) Assignee: HEWLETT-PACKARD DEVELOPMENT COMPANY, L.P., Spring, TX (US)

(21) Appl. No.: 17/796,722

(22) PCT Filed: Jan. 31, 2020
(86) PCT No.: PCT/US2020/016117

§ 371 Date: Aug. 1, 2022

(51) Int. Cl. G06F 3/041; G06F 3/044

(52) U.S. Cl. CPC G06F 3/0416; G06F 3/044; G06F 2203/04105

(57) ABSTRACT

In an example implementation according to aspects of the present disclosure, a method for controlling actuation of switches associated with a touchpad of a computing device may include detecting touch in a first zone of the touchpad, deactivating a first locking assembly of the first zone to enable actuation of a first switch associated with the first zone, upon a first depression of the touchpad in the first zone, and activating a second locking assembly of a second zone of the touchpad, separate from the first zone, wherein activation of the second locking assembly is to disable actuation of a second switch associated with the second zone, upon the first depression of the touchpad.

### BACKGROUND

Computing devices may utilize a user input device known as a touchpad or clickpad (collectively referred to herein as a “touchpad”). In some circumstances, the touchpad may be utilized along with other user input devices, such as a keyboard, for example, on a base member of a notebook computer. The touchpad may be touch sensitive so that a user may use their finger or a separate device (e.g., a stylus) to make touch inputs on the touchpad for making an input on the associated computing device. In addition, depression of the touchpad may provide additional inputs on the computing device. As a result, inputs may be received by the touchpad either by touch events on a touch sensitive surface of the touchpad, or in some circumstances by pushing or depressing the touchpad, for example, so as to actuate a switch disposed thereunder.

### BRIEF DESCRIPTION OF THE DRAWINGS

FIG. 1 illustrates a computing device for controlling the actuation of switches disposed under a touchpad, according to an example;

FIGS. 2A-B illustrate a configuration of the touchpad, having a number of zones, according to an example;

FIGS. 3A-B illustrate another configuration of the touchpad, having a number of zones, according to an example; and

FIG. 4 is a flow diagram in accordance with an example of the present disclosure.

### DETAILED DESCRIPTION

Touchpads may utilize any suitable touch-sensitive technology to register or detect touch inputs, for example, via a finger or stylus. For instance, in some examples, touchpads may include a resistive touch input assembly, a capacitive touch input assembly, a surface acoustic wave touch input assembly, an infrared touch input assembly, etc. As an example, the technology used in capacitive sensing senses the change of capacitance where a finger touches the touchpad.

With regards to the depression of the touchpad for providing additional inputs, the touchpad may also include or be coupled to a switch disposed underneath the touchpad. During operations, a user may push the touchpad, for example, into the housing of a base member of a notebook computer, by applying a sufficient level of pressure or force to a top surface of the touchpad. The depression of the touchpad into base member may eventually cause an actuation of the switch, thereby providing an input to, for example, the notebook computer (i.e., an input that may be separate and distinct from the touch inputs that may be detected on the touchpad). With regards to the switch disposed underneath the touchpad, the switch may comprise any suitable switching mechanism (e.g., button) that may be actuated to make an input to the notebook computer. For instance, the switch may comprise a so-called snap dome switch that may provide a haptic click or pop when depressed. As an example, the switch is mounted to bottom side of touchpad; however, the switch may be mounted to other surfaces under the trackpad.

Examples disclosed herein provide the ability to control the actuation of switches disposed under a touchpad. As touchpads continue to grow larger, for example, to occupy a larger area on a palm rest area of a notebook computer, multiple switches may be required under the touchpad in order to provide a satisfactory user experience. If only a single switch is mounted, for example, to the bottom side of the touchpad in the center, it may prove difficult to actuate the switch when a depression of the touchpad occurs closer to the perimeter of the touchpad (e.g., along the edges). As a result, multiple switches may be included under the touchpad in various locations in order to ensure a haptic click or pop when the touchpad is pushed at any location. As will be further described, locking assemblies may be utilized to enable or disable actuation of one or more of the switches, so that only the switch(es) in the area where touch is detected on the touchpad may be actuated when the touchpad is depressed. As a result, multiple “clicks” may not be felt when the touchpad is pushed, thereby, providing a satisfactory user experience.

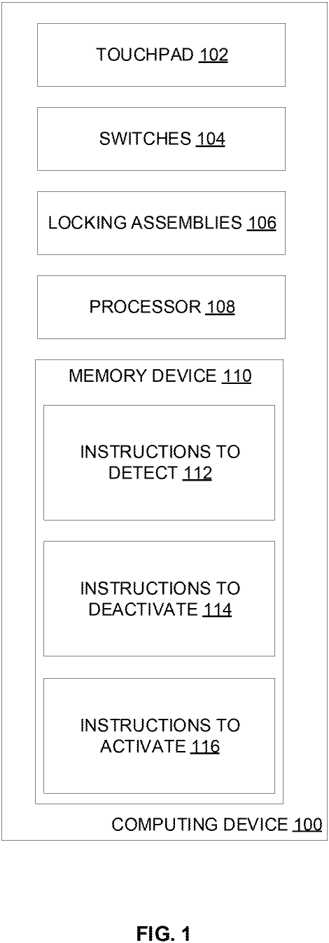

With reference to the figures, FIG. 1 illustrates a computing device 100, such as a notebook computer, for controlling the actuation of switches 104 disposed under a touchpad 102, according to an example. As an example, notebook computers generally employ a clamshell-type design consisting of two housings connected at a common end via hinges, for example. As an example, a first housing or display member is utilized to provide a viewable display to a user while a second housing or base member includes an area for user input (e.g., touchpad 102 and keyboard).

As mentioned above, multiples switches 104 may be provided under the touchpad 102, in order to ensure a haptic click or pop when the touchpad 102 is pushed at any location. The number of switches 104 included may depend on the size of the touchpad 102, or how close the manufacturer expects a “click” should be to a user’s press. As will be further described, in order to prevent the user from feeling multiple clicks from a single press on the touchpad 102, the remaining switches 104 that are away from the user’s press may be locked, for example, by a corresponding locking assembly 106. As a result, each switch 104 may include a corresponding locking assembly 106 to either enable or disable actuation of the switch 104, for example, when the touchpad 102 is depressed or pushed. As an example, each switch 104 will have a locking assembly 106 that can be locked or unlocked electrically. Tied to each locking assembly 106 is software that may control the locking assembly 106, for example, based on the user’s touch location on the touchpad 102. As will be further described, whichever zone of the touchpad 102 the user is touching may be “unlocked,” where the user will be able to click only the closest switch 104, for example, corresponding to the zone detected.

The technology for implementing the locking assembly 106 may vary. As an example, when the locking assembly 106 is activated to disable actuation of the switch 104, the locking assembly 106 may physically block depression of the touchpad 102 in a particular zone, preventing the corresponding switch 104 from being activated. However, when the locking assembly 106 is deactivated, the physical block may be removed, allowing for the corresponding switch 104 to be actuated (e.g., “clicking” sound) when touchpad 102 is pushed or depressed. As an example, a locking assembly 106 may be moved (i.e., activated or deactivated) by memory wire or a motor when triggered by a software event, as will be further described. However, movement of the locking assemblies 106 may not be limited as described.

The computing device 100 depicts a processor 108 and a memory device 110 and, as an example of the computing device 100 performing its operations, the memory device 110 may include instructions 112-116 that are executable by the processor 108. Thus, memory device 110 can be said to store program instructions that, when executed by processor 108, implement the components of the computing device 100. The executable program instructions stored in the memory device 110 include, as an example, instructions to detect (112), instructions to deactivate (114), and instructions to activate (116).

Instructions to detect (112) represent program instructions that when executed by the processor 108 cause the computing device 100 to detect touch in a zone of the touchpad 102. Based on the size of the touchpad 102, the touchpad 102 may be split between multiple zones, each zone having a corresponding switch 104 and locking assembly 106. As an example, the touchpad 102 may be split into four zones. However, the number of zones may vary. As an example, the computing device 100 may detect touch in a first zone of the touchpad 102. Referring to touchpads utilizing a capacitive touch input assembly, the computing device 100 may sense a change of capacitance in the zone where a finger (or stylus) touches the touchpad 102.

Upon detecting touch, for example, in the first zone of the touchpad 102, instructions to deactivate (114) represent program instructions that when executed by the processor 108 cause the computing device 100 to deactivate a locking assembly 106 of the first zone in order enable actuation of a switch 104 associated with the first zone, upon a depression of the touchpad 102 in the first zone. In order to avoid multiple “clicks” when the touchpad 102 is pushed, for example, in the first zone, instructions to activate (116) represent program instructions that when executed by the processor 108 cause the computing device 100 to activate locking assemblies 106 of zones besides the first zone (e.g., a second zone). By activating the locking assemblies 106 of the other zones, they disable the actuation of switches 104 associated with the other zones, for example, upon the depression of the touchpad 102 in the first zone. As a result, only the switch 104 associated with the first zone is actuated when the depression of the touchpad 102 in the first zone occurs, and the remaining switches 104 are blocked by their corresponding locking assembly 106 and not actuated. As mentioned above, the activation and deactivation of the locking assemblies 106 may vary. For example, a locking assembly 106 may be activated or deactivated by memory wire or a motor, based on the zone of the touchpad 102 that touch is detected.

As touchpads continue to grow larger, multi-touch functionality becomes more prevalent. As a result, touch may be detected in multiple zones on the touchpad 102 (e.g., via multiple fingers). Based on the application, switches 104 in the multiple zones may all be available for actuation when the touchpad 102 is pushed. Otherwise, one of the switches from the multiple zones may be available for actuation. As an example, the computing device 100 may determine the pressure applied for each touch in the multiple zones. Mechanisms for measuring the pressure may be via hardware or software functionality. For example, with regards to capacitive sensing, the computing device can determine the pressure applied for each touch by computing at the sensitivity of each touch. Upon determining the pressure applied for each touch, the computing device 100 may enable actuation of one of the switches 104, based on a comparison of the determined pressures. For example, the switch of the zone having the greater pressure may be made available for actuation when the touchpad is pushed, and the locking assemblies 106 for the other zones may be activated to disable actuation of remaining switches.

As touchpads continue to occupy larger areas on the palm rest area of a notebook computer, steps may be taken to ensure that the touch detected on the touchpad 102 is in fact intended for touch purposes. For example, as the palms of a user may rest across the touchpad while the keyboard is being used, steps may be taken to avoid accidental input. As an example, the computing device 100 may determine whether the touch detected occupies an area on the touchpad 102 that is greater than a threshold amount. Values below the threshold amount may correspond to touch, for example, from a finger or stylus. However, values above the threshold amount may correspond to touch covering a larger area on the touchpad 102, for example, from a palm. As an example, the threshold amount may be controlled, according to user preference. If the touch detected occupies an area on the touchpad 102 that is greater than the threshold amount, the computing device 100 may activate all locking assemblies 106 to disable actuation of all switches 104, to avoid accidental input, for example, from the palms of a user.

Memory device 110 represents generally any number of memory components capable of storing instructions that can be executed by processor 108. Memory device 110 is non-transitory in the sense that it does not encompass a transitory signal but instead is made up of at least one memory component configured to store the relevant instructions. As a result, the memory device 110 may be a non-transitory computer-readable storage medium. Memory device 110 may be implemented in a single device or distributed across devices. Likewise, processor 108 represents any number of processors capable of executing instructions stored by memory device 110. Processor 108 may be integrated in a single device or distributed across devices. Further, memory device 110 may be fully or partially integrated in the same device as processor 108, or it may be separate but accessible to that device and processor 108.

In one example, the program instructions 112-116 can be part of an installation package that when installed can be executed by processor 108 to implement the components of the computing device 100. In this case, memory device 110 may be a portable medium such as a CD, DVD, or flash drive or a memory maintained by a server from which the installation package can be downloaded and installed. In another example, the program instructions may be part of an application or applications already installed. Here, memory device 110 can include integrated memory such as a hard drive, solid state drive, or the like.

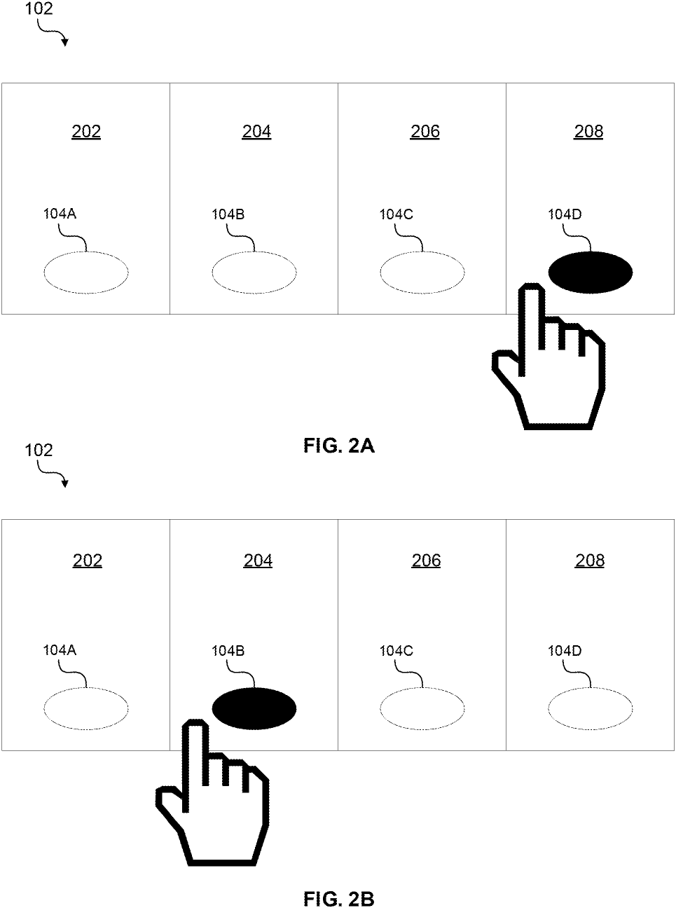

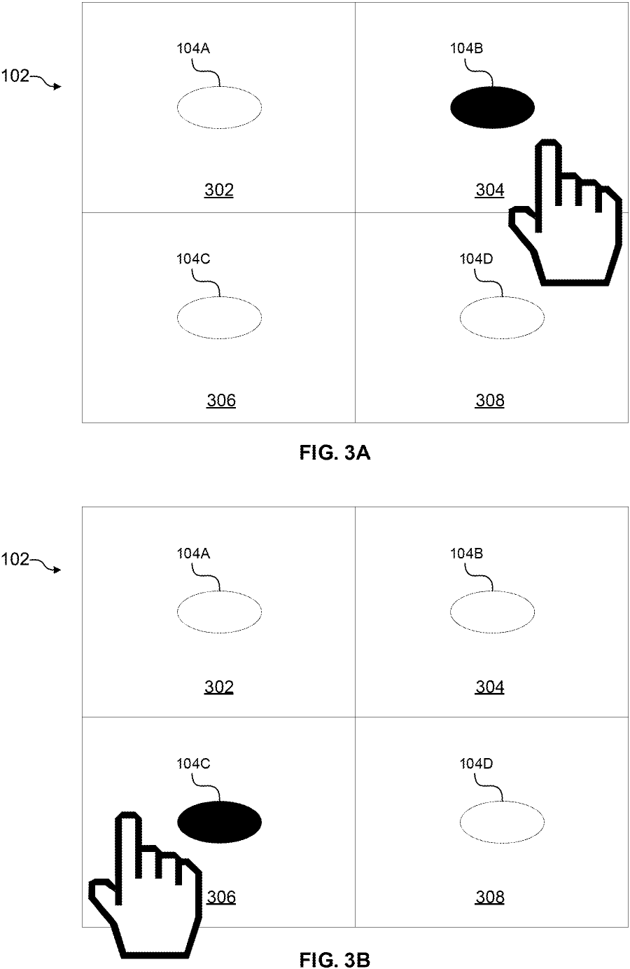

FIGS. 2A-B and FIGS. 3A-B illustrate different configurations of a touchpad 102 of computing device 100, having a number of zones. Referring to FIGS. 2A-B, touchpad 102 includes four zones 202-208 lined next to each other, for example, to occupy a larger area on a palm rest of a notebook computer, according to an example. First zone 202 includes switch 104A, second zone 204 includes switch 104B, third zone 206 includes switch 104C, and fourth zone 208 includes switch 104D. The number of zones may vary and are not limited to what is illustrated. Although not illustrated, each zone 202-208 may include a locking mechanism (e.g., locking mechanisms 106) to control the actuation of the corresponding switch 104A-D.

Referring to FIG. 2A, upon detecting touch in the fourth zone 208 (illustrated by finger), for example, via capacitive sensing, the computing device 100 may deactivate a locking assembly of the fourth zone 208 in order enable actuation of switch 104D (indicated in black), upon a depression of the touchpad 102 in the fourth zone 208. In order to avoid multiple “clicks” when the touchpad 102 is pushed in the fourth zone 208, for example, by actuation from switches 104A-C, which may not be desirable, the computing device 100 may activate locking assemblies of the first zone 202, second zone 204, and third zone 206 (i.e., all zones besides the fourth zone 208). By activating the locking assemblies of the other zones besides the fourth zone 208, they disable the actuation of switches 104A-C (indicated in white), for example, upon the depression of the touchpad 102 in the fourth zone 208, as illustrated. As a result, only switch 104D is actuated when the depression of the touchpad 102 in the fourth zone 208 occurs, and the remaining switches 104A-C are blocked by their corresponding locking assembly and not actuated.

Referring to FIG. 2B, if touch is no longer detected in the fourth zone 208, but in the second zone 204, the computing device 100 may activate the locking assembly of the fourth zone 208 to disable actuation of the fourth switch 104D (indicated in white), and deactivate the locking assembly of the second zone 204 to enable actuation of the second switch 104B (indicated in black), upon a depression of the touchpad 102 in the second zone 204.

Referring to FIGS. 3A-B, touchpad 102 includes four zones 302-308 arranged as illustrated, according to an example. First zone 302 includes switch 104A, second zone 304 includes switch 104B, third zone 306 includes switch 104C, and fourth zone 308 includes switch 104D. The number of zones may vary and are not limited to what is illustrated. Although not illustrated, each zone 302-308 may include a locking mechanism (e.g., locking mechanisms 106) to control the actuation of the corresponding switch 104A-D.

Referring to FIG. 3A, upon detecting touch in the second zone 304 (illustrated by finger), for example, via capacitive sensing, the computing device 100 may deactivate a locking assembly of the second zone 304 in order enable actuation of switch 104B (indicated in black), upon a depression of the touchpad 102 in the second zone 304. In order to avoid multiple “clicks” when the touchpad 102 is pushed in the second zone 304, for example, by actuation from switch 104A and switches 104C-D, which may not be desirable, the computing device 100 may activate locking assemblies of the first zone 302, third zone 306, and fourth zone 308 (i.e., all zones besides the second zone 304). By activating the locking assemblies of the other zones besides the second zone 304, they disable the actuation of switch 104A and switches 104C-D (indicated in white), for example, upon the depression of the touchpad 102 in the second zone 304, as illustrated. As a result, only switch 104B is actuated when the depression of the touchpad 102 in the second zone 304 occurs, and the remaining switches (104A and 104C-D) are blocked by their corresponding locking assembly and not actuated.

Referring to FIG. 3B, if touch is no longer detected in the second zone 304, but in the third zone 306, the computing device 100 may activate the locking assembly of the second zone 304 to disable actuation of the second switch 104B (indicated in white), and deactivate the locking assembly of the third zone 306 to enable actuation of the third switch 104C (indicated in black), upon a depression of the touchpad 102 in the third zone 306.

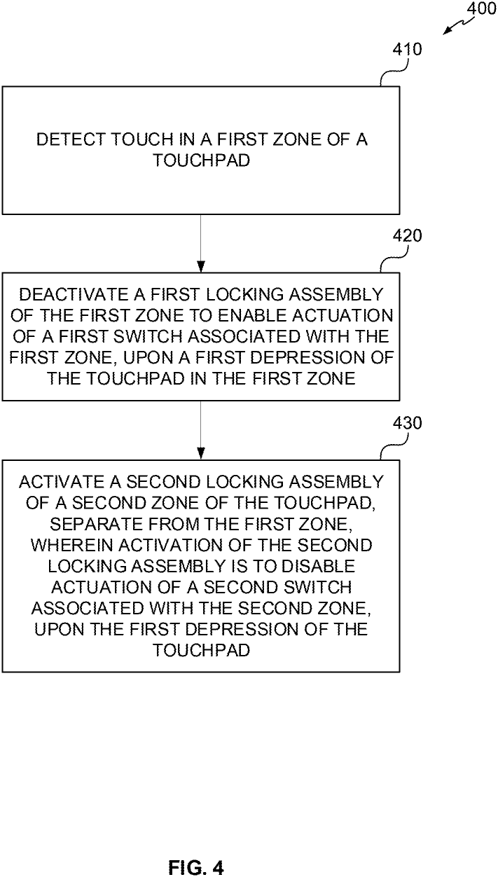

FIG. 4 is a flow diagram 400 of steps taken by a computing device to control the actuation of switches disposed under a touchpad, according to an example. Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

At 410, the computing device detects touch in a first zone of the touchpad. As an example of touchpads utilizing a capacitive touch input assembly, the computing device may sense a change of capacitance in the zone where a finger (or stylus) touches the touchpad (e.g., first zone).

At 420, the computing device deactivates a first locking assembly of the first zone to enable actuation of a first switch associated with the first zone, upon a first depression of the touchpad in the first zone. At 430, the computing device activates a second locking assembly of a second zone of the touchpad, separate from the first zone, wherein activation of the second locking assembly is to disable actuation of a second switch associated with the second zone, upon the first depression of the touchpad. Although two zones are described, the number of zones may vary, as described above.

As an example, upon determining touch is no longer detected in the first zone, the computing device may activate the first locking assembly to disable actuation of the first switch, upon a second depression of the touchpad outside the first zone. If touch is later detected in the second zone, in addition to activating the first locking assembly, the computing device may deactivate the second locking assembly to enable actuation of the second switch, upon the second depression of the touchpad.

As touchpads continue to grow larger, multi-touch functionality becomes more prevalent. As a result, touch may be detected in multiple zones on the touchpad (e.g., via multiple fingers). As an example, if the computing device determines that touch is detected in both the first zone and the second zone, the computing device determine a first pressure of the touch in the first zone and a second pressure of the touch in the second zone. As a result, the computing device may enable actuation of either the first switch or the second switch, based on a comparison of the first pressure and the second pressure, upon a depression of the touchpad. As an example, if the second pressure is greater than the first pressure, the computing device may activate the first locking assembly to disable actuation of the first switch, and deactivate the second locking assembly to enable actuation of the second switch, upon a depression of the touchpad.

As touchpads continue to occupy larger areas on the palm rest area of a notebook computer, steps may be taken to ensure that the touch detected on the touchpad is in fact intended for touch purposes. For example, as the palms of a user may rest across the touchpad while the keyboard is being used, steps may be taken to avoid accidental input. As an example, if the touch detected occupies an area on the touchpad that is greater than a threshold amount, the computing device may activate both the first locking assembly and the second locking assembly to disable actuation of both the first switch and the second switch, respectively, upon a depression of the touchpad.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A method for controlling actuation of switches associated with a touchpad of a computing device, the method comprising:
detecting touch in a first zone of the touchpad;
deactivating a first locking assembly of the first zone to enable actuation of a first switch associated with the first zone, upon a first depression of the touchpad in the first zone; and
activating a second locking assembly of a second zone of the touchpad, separate from the first zone, wherein activation of the second locking assembly is to disable actuation of a second switch associated with the second zone, upon the first depression of the touchpad.

2. The method of claim 1, wherein, upon determining touch is no longer detected in the first zone, further comprising:
activating the first locking assembly to disable actuation of the first switch, upon a second depression of the touchpad outside the first zone.

3. The method of claim 1, wherein, upon determining touch is detected in the second zone, further comprising:
activating the first locking assembly to disable actuation of the first switch, upon a second depression of the touchpad in the second zone; and
deactivating the second locking assembly to enable actuation of the second switch, upon the second depression of the touchpad.

4. The method of claim 1, wherein, upon determining touch is detected in both the first zone and the second zone, further comprising:
determining a first pressure of the touch in the first zone;
determining a second pressure of the touch in the second zone; and
enabling actuation of either the first switch or the second switch, based on a comparison of the first pressure and the second pressure, upon a second depression of the touchpad.

5. The method of claim 4, wherein if the second pressure is greater than the first pressure, further comprising:
activating the first locking assembly to disable actuation of the first switch, upon the second depression of the touchpad; and
deactivating the second locking assembly to enable actuation of the second switch, upon the second depression of the touchpad.

6. The method of claim 1, wherein if the touch detected occupies an area on the touchpad that is greater than a threshold amount, further comprising:
activating both the first locking assembly and the second locking assembly to disable actuation of both the first switch and the second switch, respectively, upon a second depression of the touchpad.

7. A computing device comprising:
a housing;
a touchpad coupled to the housing;
switches disposed within the housing, under the touchpad;
locking assemblies to either enable or disable actuation of corresponding switches, upon a depression of the touchpad; and
a processor to:
detect touch in a first zone of the touchpad;
deactivate a first locking assembly of the locking assemblies that is associated with the first zone to enable actuation of a first switch of the switches that is associated with the first zone, upon a first depression of the touchpad in the first zone; and
activate remaining locking assemblies of the locking assemblies that are associated with other zones of the touchpad, separate from the first zone, wherein activation of the remaining locking assemblies are to disable actuation of remaining switches of the switches that are associated with the other zones, upon the first depression of the touchpad.

8. The computing device of claim 7, wherein, upon determining touch is no longer detected in the first zone, the processor is to:
activate the first locking assembly to disable actuation of the first switch, upon a second depression of the touchpad outside the first zone.

9. The computing device of claim 7, wherein, upon determining touch is detected in both the first zone and a second zone of the touchpad, the processor is to:
determine a first pressure of the touch in the first zone;
determine a second pressure of the touch in the second zone; and
enable actuation of either the first switch or the second switch, based on a comparison of the first pressure and the second pressure, upon a second depression of the touchpad.

10. The computing device of claim 9, wherein if the second pressure is greater than the first pressure, the processor is to:
activate the first locking assembly to disable actuation of the first switch, upon the second depression of the touchpad; and
deactivate a locking assembly of the locking assemblies that is associated with the second zone to enable actuation of a switch of the switches that is associated with the second zone, upon the second depression of the touchpad.

11. The computing device of claim 7, wherein if the touch detected occupies an area on the touchpad that is greater than a threshold amount, the processor is to:
activate all locking assemblies to disable actuation of all switches, upon a second depression of the touchpad.

12. A non-transitory computer-readable storage medium comprising program instructions which, when executed by a processor of a computing device, cause the processor to:
detect touch in a first zone of a touchpad of the computing device;
deactivate a first locking assembly of the first zone to enable actuation of a first switch associated with the first zone, upon a first depression of the touchpad in the first zone; and
activate a second locking assembly of a second zone of the touchpad, separate from the first zone, wherein activation of the second locking assembly is to disable actuation of a second switch associated with the second zone, upon the first depression of the touchpad.

13. The non-transitory computer-readable storage medium of claim 12, wherein, upon determining touch is detected in the second zone, further comprising instructions that, when executed by the processor, cause the processor to:
activate the first locking assembly to disable actuation of the first switch, upon a second depression of the touchpad in the second zone; and
deactivate the second locking assembly to enable actuation of the second switch, upon the second depression of the touchpad.

14. The non-transitory computer-readable storage medium of claim 12, wherein, upon determining touch is detected in both the first zone and the second zone, further comprising instructions that, when executed by the processor, cause the processor to:
determine a first pressure of the touch in the first zone;
determine a second pressure of the touch in the second zone; and
enable actuation of either the first switch or the second switch, based on a comparison of the first pressure and the second pressure, upon a second depression of the touchpad.

15. The non-transitory computer-readable storage medium of claim 12, wherein if the touch detected occupies an area on the touchpad that is greater than a threshold amount, further comprising instructions that, when executed by the processor, cause the processor to:
activate both the first locking assembly and the second locking assembly to disable actuation of both the first switch and the second switch, respectively, upon a second depression of the touchpad.
